(19) United States
(12) Patent Application Publication
(10) Pub. No.: US 2007/0187171 A1
(43) Pub. Date: Aug. 16, 2007

(54) Production method of an acoustic diaphragm, acoustic diaphragm, and a speaker

(75) Inventors: Yoshiaki Suzuki, Kanagawa-ken (JP); Yoshiaki Tanaka, Kanagawa-ken (JP)

Correspondence Address: NATH & ASSOCIATES, PLLC, Sixth Floor, 1030 15th Street, N.W., Washington, DC, 20005, US

(73) Assignee: VICTOR COMPANY OF JAPAN, LIMITED

(21) Appl. No.: 11/698,167

(22) Filed: Jan. 26, 2007

(30) Foreign Application Priority Data
Jan. 27, 2006 (JP) P2006-019101
Jan. 27, 2006 (JP) P2006-019105
Oct. 17, 2006 (JP) P2006-282464
Oct. 17, 2006 (JP) P2006-282466

(51) Int. Cl. H04R 7/00; G10K 13/00

(52) U.S. Cl. 181/167; 181/169

(57) ABSTRACT

A method of producing an acoustic diaphragm includes forming a workpiece having a shape of the acoustic diaphragm by using a natural material which can be carbonized by burning, impregnating a solution including phenol resin into the workpiece, heating the workpiece to bring the phenol resin into a high polymer state, burning the workpiece in a substantially anoxic atmosphere to carbonize the natural material after the heating step, and applying or impregnating the workpiece with a coating material of a solution including phenol resin after the burning step.

### CROSS REFERENCE TO RELATED APPLICATIONS

This application is based upon and claims the benefit of priority from the prior Japanese Patent Applications No. P2006-19101, P2006-19105, filed on Jan. 27, 2006, and P2006-282464, P2006-282466, filed on Oct. 17, 2006; the entire contents of which are incorporated herein by reference.

### BACKGROUND OF THE INVENTION

1. Field of the Invention

The present invention relates to a method of producing an acoustic diaphragm, an acoustic diaphragm, and a speaker using the acoustic diaphragm.

2. Description of the Related Art

As an acoustic diaphragm for a speaker that emits a clear sound with minimum distortion, a diaphragm having a high carbonization ratio has been attracted attention. A diaphragm with a high carbonization ratio is obtained by burning a natural diaphragm material that includes various types of organic matter at a high temperature to carbonize the organic matter. A large number of fine holes are generated in the diaphragm as it is carbonized. As a result, air leakage occurs when such a diaphragm is used as a speaker. The air leakage causes sound deterioration, which is a problem to be solved for an acoustic diaphragm used in a speaker.

Air leakage that occurs in an acoustic diaphragm in a speaker will be described. An acoustic diaphragm in a speaker vibrates in response to electronic signals to push and pull air around the diaphragm. As a result, compression wave (longitudinal wave which vibrates in the same direction as the wave passing through) of air according to the electronic signals is generated and a person senses the vibrations as sounds. In a series of operations, when there is a through hole penetrating from the front surface to the rear surface of the acoustic diaphragm, air around (particularly in front of) the diaphragm will not be pushed or pulled by vibrations of the acoustic diaphragm so that a compression air wave is not generated. Thus, the amount of compression waves for an entire speaker is decreased and the amount that a person hears as sound is decreased.

Since a new airflow is generated in the through hole that penetrates from the front surface to the rear surface of the acoustic diaphragm according to the vibrations of the acoustic diaphragm, other compression air wave, which is different from the original compression air wave, is generated. The other compression air wave creates noise and the noise causes sound deterioration.

Examples of conventional carbonized acoustic diaphragms will be described. Japanese Unexamined Patent Application Laid-Open (Koukai) No. 60(1985)-54596 (hereinafter called “JP 60-54596”) discloses that when a thin metal layer made from a material such as boron and beryllium is provided on a carbonized surface, a more rigid diaphragm is obtained. However, JP 60-54596 does not disclose a feature for air leakage. Also, it is not clear whether or not the thin metal layer can prevent the air leakage. JP 60-54596 discloses that manageability of the diaphragm is improved when a material such as acrylic lacquer is applied on the surface of the thin metal layer. However, it is not still clear that the above thin metal layer can prevent the air leakage.

Similar to JP 60-54596, Japanese Examined Patent Publication (Koukoku) No. 57(1982)-31356 (hereinafter called “JP 57-31356”) discloses that when a thin metal layer made from a material such as boron and beryllium is provided on a burned and carbonized surface, a diaphragm with increased rigidity is obtained. However, JP 57-31356 does not disclose the feature for air leakage and it is not clear whether or not the thin metal layer prevents the air leakage.

Japanese Unexamined Patent Application Laid-Open No. 2002-34096 (hereinafter called “JP 2002-34096”) discloses that a liquid mixture of dye and pigment is impregnated into a burned porous surface material to produce a surface color. However, JP 2002-34096 does not disclose a feature for preventing air leakage and it is not clear whether or not the impregnated burned porous surface prevents the air leakage.

As described above, JP 60-54596, JP 57-31356 and JP 2002-34096 are inventions to obtain an acoustic diaphragm by a burning process. However, materials to be burned and materials to be applied are different. Any effective feature for an air leakage is not taken or is not sufficient.

### SUMMARY OF THE INVENTION

An object of the present invention is to cover the fine holes of a diaphragm having a high carbonization ratio which are generated in a process of burning a natural diaphragm material containing various types of organic matter and to prevent sound deterioration due to air leakage when the diaphragm is used in a speaker.

Another object of the present invention is to realize an improvement in the strength of the acoustic diaphragm having a high carbonization ratio and to improve the manageability in an assembling process of a speaker using the diaphragm and to improve the strength reliability of the speaker.

Another object of the present invention is to increase internal losses of an acoustic diaphragm and to absorb strain components of the diaphragm used in a speaker, in order to improve frequency characteristic.

According to an aspect of the present invention, firstly, a workpiece is formed in a shape of the acoustic diaphragm. The diaphragm is formed from a natural material of organic matter that is carbonized by burning. After, a solution containing phenol resin is applied to the obtained workpiece. The workpiece is heated to a predetermined temperature to bring the phenol resin into a high polymer state. Then, the workpiece is burned under a substantially anoxic atmosphere to carbonize the organic matter. Although these foregoing processes are substantially the same as conventional techniques, according to the present invention, the burned workpiece is applied or impregnated with a coating material including a solution containing phenol resin.

In the present invention, the “natural material” represents materials found in nature such as wood, paper pulp, natural fiber (including botanical fiber and animal fiber), fabric or string of the natural fiber, leather, or combined material of the above and processed materials made of materials found in nature. Natural materials include carbon and have an advantage of having fine shapes. In the following embodiments, cotton fiber and softwood fiber are used as natural materials; however, hemp fiber and broadleaf fiber or the like may be also employed.

As a coating material including a solution of phenol resin (hereinafter referred to as “phenol resin coating material”), a solution prepared by dissolving phenol resin into a solvent containing water and alcohols having a low boiling temperature (lower than about 80° C.) such as methanol and ethyl acetate is preferable for increasing the productivity and the yield. Such a phenol resin coating material has an advantage that its quality is reliable compared to natural materials so that a certain level of quality can be easily obtained.

Portions of the workpiece where the phenol resin coating material is applied is not limited as long as it is effective to prevent air leakage; however, since an edge of the workpiece has a large number of openings of vessels in wood, it is particularly effective to apply the phenol resin coating material to the edge of the workpiece. Further, when the phenol resin coating material is applied only to the edge, the weight of the diaphragm can be decreased so that it provides excellent acoustic properties.

According to another aspect of the present invention, a workpiece is formed in the shape of an acoustic diaphragm using a natural material including organic matter that is carbonized by burning. After a solution containing phenol resin is applied to the obtained workpiece, the workpiece is heated to a predetermined temperature to bring the phenol resin into a high polymer state. Then, the workpiece is burned under a substantially anoxic atmosphere to carbonize the organic matter. Although these foregoing processes are substantially the same as conventional techniques, according to the present invention, the burned workpiece has applied thereon or impregnated with a lacquer (Japanese lacquer) coating material. The workpiece is hardened by at least one method of keeping the obtained workpiece under a predetermined degree of humidity or heating the obtained workpiece at a predetermined temperature.

Here, as another means, there may be a method for applying an organic water-soluble resin coating material containing resin as a major ingredients (such as polyvinyl alcohol and nitrocellulose) dissolved in a solvent having a low boiling temperature (lower than about 80° C.) such as methanol and ethyl acetate. However, when a solvent having a low boiling temperature is employed, an organic solvent in the fine holes of the carbonized diaphragm evaporates rapidly. In this event, evaporation pressure is created. The evaporation pressure causes fractures in the carbonized diaphragm.

On the other hand, the lacquer coating material contains lacquer oil and moisture but does not contain the organic solvent having a low boiling temperature. Accordingly, when the lacquer coating material is employed, such a rapid evaporation pressure is not created. Further, since a reaction of hardening the lacquer coating material progresses slowly, moisture in the lacquer coating material will evaporate progressively and be completely removed. Therefore, applying a lacquer coating material to a diaphragm having a high carbonization ratio prevents fractures and covers the fine through holes in the diaphragm.

Further, a hardened membrane is formed by hardening lacquer ingredients, which are a state of oil in the lacquer coating material, due to a reaction catalyzed by an enzyme contained in the moisture in the lacquer coating material. Here, the same effect can be obtained by using an oil-in-water type coating material by completely mixing water and oil, in which a laccase is provided in water as enzyme and an urushiol is used as an oil.

When a lacquer coating material containing urushiol as a major ingredient is used, a hardened membrane can be also obtained not only by enzymic reaction but also by high-temperature processing at over 120° C. Thus, after a carbonized diaphragm is applied with or impregnated with the lacquer coating material, the object of the present invention can be achieved sufficiently by heating the diaphragm at over 120° C., preferably around 150° C.

The lacquer coating material of the oil-in-water type may be diluted by water or a hydrocarbon solvent (Hydrocarbon solvent represents aliphatic hydrocarbon, aromatic hydrocarbon, hydrogenated hydrocarbon, terpene hydrocarbon, and halogenated hydrocarbon and, here, examples of kerosene and turpentine oil will be described). In this case, more moisture is used in order to slow the hardening and more solvent is used in order to decrease the degree of viscosity and increase permeability. A lacquer coating material having an appropriate component mixture ratio can be used, depending on the condition of the size, or distribution of the fine holes of the carbonized diaphragm. Applying the lacquer coating material in this way is effective not only for preventing air leakage but also for adjusting strength and internal losses of the diaphragm.

Since the lacquer coating material is made of natural materials, it is more preferable than synthesized materials made by coal oil in view of environmental protection. On the other hand, since lacquer is a natural material, there are some disadvantages such that wide variations in quality are found and that a person who treats the material may have a skin irritation. However, once it is made into a product, it is safe for people and overcomes environmental issues.

Portions of the workpiece where the lacquer coating material is applied is not limited as long as it is effective to prevent air leakage; however, since edge portions of the workpiece has a large number of openings of vessels in wood, it is particularly effective to apply the lacquer coating material to the edge portions of the workpiece. Further, when the phenol resin coating material is applied only to the edge portions, the weight of the diaphragm can be reduced so that it is effective for enhancing acoustic properties.

According to the acoustic diaphragm produced by the production method of the present invention, fine holes in the diaphragm are covered so that air leakage does not occur when a speaker using the acoustic diaphragm is driven. As a result, sound deterioration is prevented.

Further, the fine holes in the diaphragm are covered so that the strength of the diagram is increased. As a result, the acoustic diaphragm will not easily damaged when a speaker is assembled with the diaphragm and its production manageability is increased.

Further, since internal losses of the acoustic diaphragm are increased to absorb strain components when the diaphragm is used in a speaker, frequency characteristic will be improved.

### BRIEF DESCRIPTION OF THE DRAWINGS

In the accompanying drawings:

FIG. 1 is a flowchart of a production method according to a first embodiment of the present invention;

FIGS. 2A to 2G are explanatory diagrams of the production method according to the first embodiment of the present invention;

FIG. 3 is a graph showing a characteristic feature of an acoustic diaphragm according to the first embodiment of the present invention;

FIG. 4 is a flowchart of a production method according to a second embodiment of the present invention;

FIGS. 5A to 5G are explanatory diagrams of the production method according to the second embodiment of the present invention;

FIG. 6 is a flowchart of a production method according to a third embodiment of the present invention;

FIGS. 7A to 7H are explanatory diagrams of the production method according to the third embodiment of the present invention;

FIG. 8 is a graph showing a characteristic feature of an acoustic diaphragm according to the third embodiment of the present invention;

FIG. 9 is a flowchart of a production method according to a fourth embodiment of the present invention;

FIGS. 10A to 10G are explanatory diagrams of the production method according to the fourth embodiment of the present invention;

FIG. 11 is a flowchart of a production method according to a fifth embodiment of the present invention;

FIGS. 12A to 12G are explanatory diagrams of the production method according to the fifth embodiment of the present invention; and

FIG. 13 is a speaker according to the present invention.

### DESCRIPTION OF THE PREFERRED EMBODIMENTS

Various embodiments of the present invention will be described with reference to the accompanying drawings.

### First Embodiment

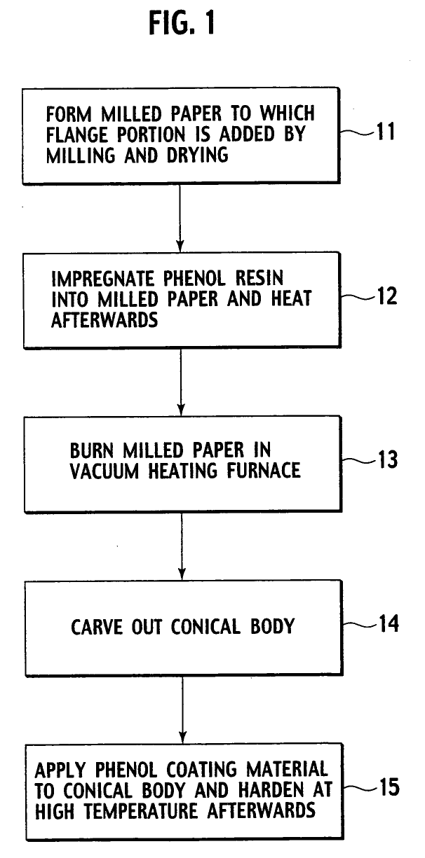

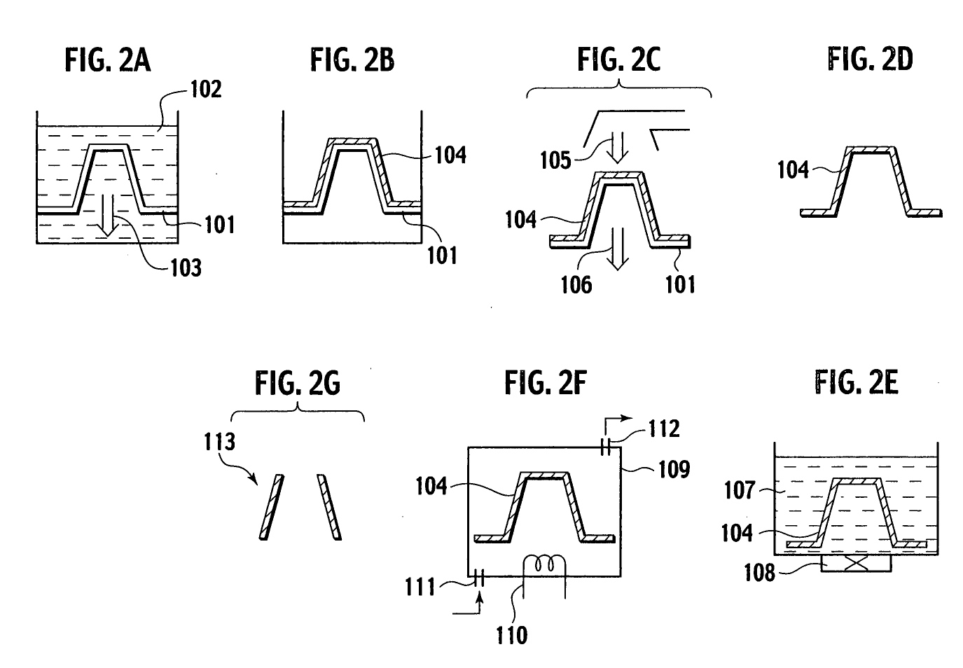

A first embodiment of the present invention will be described. FIGS. 1 and 2A to 2F are explanatory diagrams of a production method according to the first embodiment.

At a first step 11 in FIG. 1, as shown in FIG. 2A, a previously formed mesh 101 having a center portion has a conical shape (truncated shape) is prepared. (Since the workpiece contracts due to a burning operation, the mesh may be formed larger than the size of the workpiece after the burning operation. For example, when it is heated at 800° C., contraction of, for example, 25% in the longitudinal direction is taken into consideration, and the mesh is formed larger by this value.) The mesh 101 is put into a dispersion liquid 102 into which mixture fiber of 90 wt % of linter (cotton fiber) 10 wt %+NBKP [Needle Bleach Kraft Pulp] (softwood fiber is made into pulp by the kraft process and is further bleached) is dispersed, and the mixture fiber is milled into paper on the mesh 101. A reference number 103 in FIG. 2A represents a suction direction when paper is milled, and a reference number 104 in FIG. 2B represents milled paper. The mesh 101 can be made of metal such as brass; however, the material is not limited to metals and any strong and heat resistant material can be used.

To remove moisture from the milled paper 104 on the mesh 101, hot air 105 (e.g., in a range of 100° C. to 200° C., as an example, at 150° C.) is blown on the milled paper 104 and the mesh 101 is vacuum-sucked from below at the same time as shown in FIG. 2C. A reference number 106 in FIG. 2C represents the vacuum-suction airflow.

At a second step 12 in FIG. 1, the milled paper 104 is detached from the mesh 101 as shown in FIG. 2D, and is immediately immersed in an alcohol solution 107 of phenol resin (phenol resin containing ratio is about 15 wt %) and is impregnated with the alcohol solution 107 as shown in FIG. 2E. At that time, the entire alcohol solution 107 of phenol resin is subjected to ultrasonic oscillation for about five minutes by an ultrasonic oscillator 108 for example, so that the alcohol solution 107 is fully permeated into the milled paper 104. The milled paper 104 is taken out from the solution 107 and sufficiently dried, and the milled paper 104 is then heated for about ten minutes at about 180° C. so that the phenol resin, which is a short molecule, is brought into a high polymer state.

Next, at a third step 13 in FIG. 1, as shown in FIG. 2F, the milled paper 104 impregnated with phenol resin is placed in a vacuum heating furnace 109, and is heated from a room temperature to 800° C. by a heater 110 in a substantially anoxic atmosphere (for example, nitrogen gas atmosphere). After the milled paper 104 is held for 30 minutes at 800° C., it is gradually cooled to the room temperature and is taken out from the furnace. With this step, the organic matter included in the milled paper 104 is carbonized. Thus, a large number of fine holes are formed in the milled paper 104 so as to be porous. A reference number 111 represents an introduction port for nitrogen gas or the like, and a reference number 112 represents a discharge port for nitrogen gas or the like.

Next, at a fourth step 14 in FIG. 1, as shown in FIG. 2G, a porous carbide conical body 113 is carved out by cutting. When paper is milled, if a small step portion is formed at a boundary between the conical shaped portion and the flat portion of the milled paper 104, it can be cut by a router or a laser cutter, or the like using the small step portion as a guideline, so it is possible to obtain a precise shape.

Next, at a fifth step 15 in FIG. 1, a phenol resin coating material (containing methanol of about 10 wt % and moisture of about 40 wt %) is applied to edge portions and the entire surface of the porous carbide 113. After the porous carbide 113 is dried, it is heated in an atmosphere of substantially 180° C. so as to be almost entirely hardened. The almost entirely hardened workpiece is effective to prevent air leakage when the workpiece is used as an acoustic diaphragm.

Since the phenol resin coating material is water-soluble, it permeates into the holes of the porous carbide when the porous carbide is coated by or impregnated with the phenol resin coating material. Thus, the probability of fracture of the carbonized diaphragm is remarkably reduced. Further, since the phenol resin coating material permeates into the holes of the porous carbide and forms a phenol resin film (hardened material of the phenol resin coating material) inside and around the carbonized material, the strength of the carbonized material as an acoustic diaphragm is increased. At the same time, since the phenol resin film increases internal losses to absorb strain components when the diaphragm is installed as a speaker, the frequency characteristic will be improved.

Further, since phenol resin is a material that withstands long use under a high-temperature environment over 100° C., an acoustic diaphragm according to the present invention can be applied to a speaker which can withstand long use under a high-humidity environment. Further, since phenol resin has ultraviolet resistance, the acoustic diaphragm according to the present invention can be applied to a PA (public address system) placed in an outdoor severe environment (for example, at sports stadiums, outdoor theaters, stations, bus stops, and the like). There is little quality variation in phenol resin compared to natural materials so that phenol resin is industrially easy to handle.

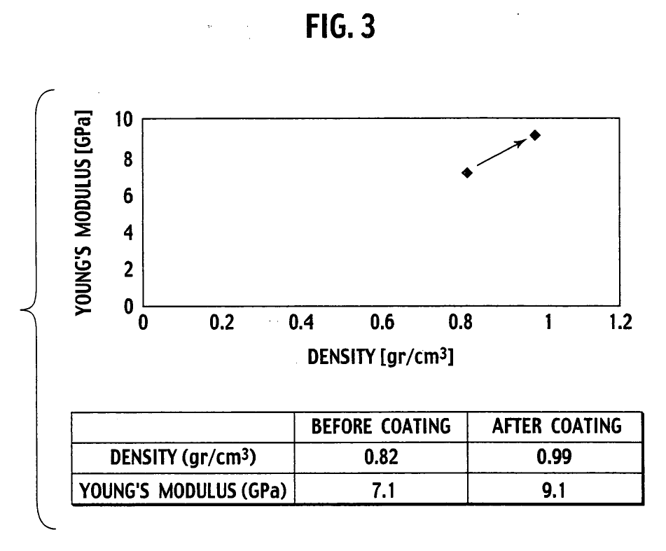

For example, when a workpiece is almost entirely hardened by heating for 30 minutes at 180° C., increased weight of the workpiece is about 20 wt % (compared to the porous carbide 113 before being coated by the phenol resin coating material). However, the weight is within a range required for an acoustic diaphragm and the Young's modulus increases about 28% from 7.1 GPa of a workpiece before coating to 9.1 GPa of a workpiece after coating (compared to the porous carbide 113 before being coated by the phenol resin coating material). As a result, a sufficient strength is implemented to the diaphragm so as not to be damaged in an assemble process of a speaker using the acoustic diaphragm. A relationship between the Young's modulus and the density before and after coating is shown in FIG. 3.

While it is preferable to use nitrogen gas as the anoxic atmosphere because it is inexpensive and is readily available, argon, high vacuum atmosphere, and the like can be used other than the nitrogen gas.

Further, in the present embodiment, material containing 40 wt % of moisture as a phenol resin coating material is used. However, the moisture amount is not limited to the above-described value and a material containing about 5 wt % to 70 wt % of moisture may also be used. When a carbonized diaphragm is coated with a material containing less than 4 wt % of moisture, the probability of fracture occurring in a carbonized diaphragm is extremely high. When the carbonized diaphragm is coated with a material containing more than 75 wt % of moisture, the phenol resin coating material becomes clouded. In the present embodiment, alcohol concentration is preferably in a range of from 5 wt % to 90 wt %, and the phenol resin concentration is preferably more than 5 wt %. The optimum value of those densities should be arbitrarily set according to the weight of a required acoustic diaphragm.

### Second Embodiment

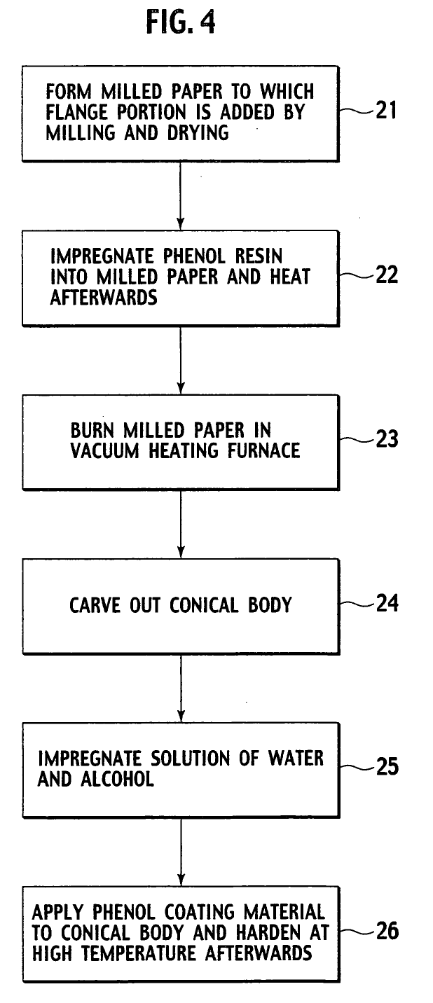

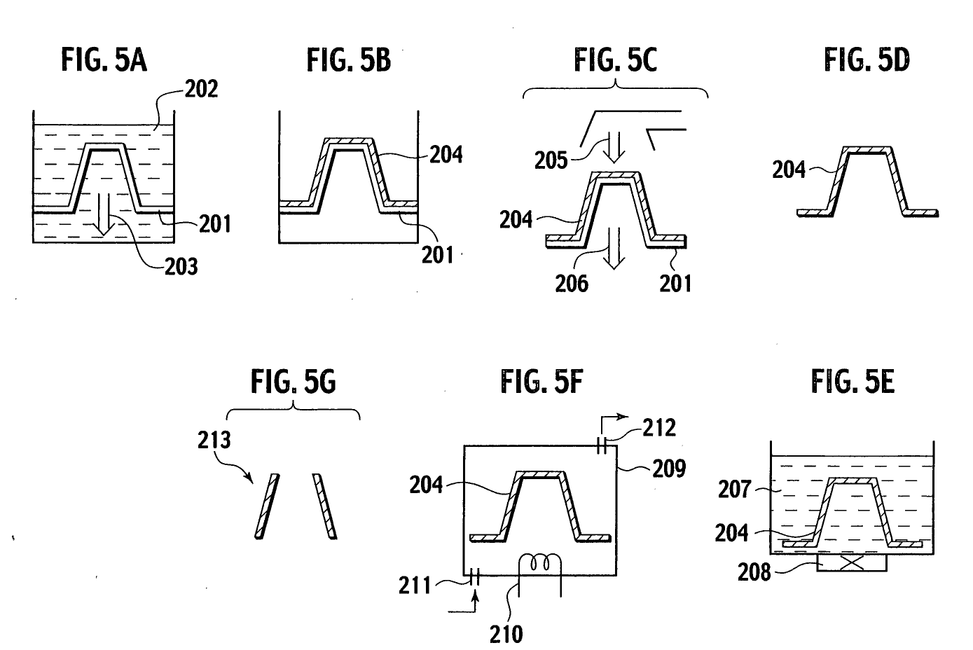

FIGS. 4 and 5A to 5G are explanatory diagrams of a production method according to the second embodiment.

At a first step 21 in FIG. 4, as shown in FIG. 5A, a previously formed mesh 201 having a center portion has a conical shape (truncated shape) is prepared. (Since the workpiece contracts due to a burning operation, the mesh may be formed larger than the size of the workpiece after the burning operation. For example, when it is heated at 800° C., contraction of, for example, 25% in the longitudinal direction is taken into consideration, and the mesh is formed larger by this value). The mesh 201 is put into a dispersion liquid 202 into which mixture fiber of 90 wt % of linter (cotton fiber) 1 wt %+NBKP [Needle Bleach Kraft Pulp] (softwood fiber is made into pulp by a kraft process and is further bleached) is dispersed, and the mixture fiber is milled into paper on the mesh 201.

A reference number 203 represents a suction direction when paper is milled, and a reference number 204 in FIG. 5B represents milled paper. The mesh 201 can be made of metal such as brass, but the material is not limited to this, and any strong and heat resistant material can be used.

To remove moisture from the milled paper 204 on the mesh 201, hot air 205 (e.g., in a range of 100° C. to 200° C., as an example, at 150° C.) is blown on the milled paper 204 and the mesh 201 is vacuum-sucked from below at the same time as shown in FIG. 5C. A reference number 206 represents the vacuum-suction airflow.

At a second step 22 in FIG. 4, the milled paper 204 is detached from the mesh 201 as shown in FIG. 5D, and is immediately immersed in alcohol solution 207 of phenol resin (phenol resin containing ratio is about 15 wt %) as shown in FIG. 5E, and the alcohol solution 207 is impregnated into the paper. At that time, the entire alcohol solution 207 of phenol resin is subjected to ultrasonic oscillation for about five minutes by an ultrasonic oscillator 208 so that the alcohol solution 207 fully impregnates into the milled paper 204.

The milled paper 204 is taken out from the solution 207 and sufficiently dried, and the milled paper 204 is then heated for about ten minutes at about 180° C. so that the phenol resin, which is a short molecule, is brought into a high polymer state.

Next, at a third step 23 in FIG. 4, as shown in FIG. 5F, the milled paper 204 in which phenol resin is impregnated is placed in a vacuum heating furnace 209, and is heated from a room temperature to 800° C. by a heater 210 in a substantially anoxic atmosphere (for example, nitrogen gas atmosphere). After the milled paper 204 is held for 30 minutes at 800° C., it is gradually cooled to the room temperature and is taken out from the furnace. With this step, the organic matter included in the milled paper 204 is carbonized. With this step, a large number of fine holes are formed in the milled paper 204 so as to form a porous carbide. A reference number 211 represents an introduction port for nitrogen gas or the like, and a reference number 212 represents a discharge port for nitrogen gas or the like.

Next, at a fourth step 24 in FIG. 4, as shown in FIG. 5G, a porous carbide conical body 213 is carved out by cutting. When paper is milled, if a small step portion is formed at a boundary between the conical shaped portion and the flat portion of the milled paper 204, it can be cut by a router, a laser cutter, or the like using the small step potion as a guideline, so it is possible to obtain a precise shape.

Next, at a fifth step 25 in FIG. 4, edge portions and the entire surface of the porous carbide 213 are impregnated with a mixed liquid containing 50 wt % of methanol and 50 wt % of moisture.

At a sixth step 26 in FIG. 4, a phenol resin coating material (containing methanol of about 10 wt % and moisture of about 40 wt %) is applied to the edge and the entire surface of the porous carbide 213. After the porous carbide 213 is dried, it is heated for 30 minutes in an atmosphere at substantially 100° C., and further heated for 30 minutes in an atmosphere at substantially 180° C. so as to be almost entirely hardened. The almost entirely hardened workpiece is effective to fill the holes of the porous carbide 213 and can prevent air leakage when the workpiece is used as an acoustic diaphragm.

Since the phenol resin coating material is water-soluble, it permeates into the holes in the porous carbide when the porous carbide is coated by or impregnated with the phenol resin coating material. As a result, the occurrence of fractures of the carbonized diaphragm is remarkably reduced. Further, since a great deal of the phenol resin coating material permeates into the holes located near the surface of the porous carbide and forms a phenol resin film (hardened material) near the surface of the porous carbide, the rest of the phenol resin does not enter the holes located on the inner side of the porous carbide. Accordingly, a lightweight and strong carbonized material, for use as an acoustic diaphragm, is realized. Further, since the phenol resin film improves internal losses of the porous carbide, distortion of the carbonized material as an acoustic diaphragm is prevented. At the same time, since generated strain components are absorbed, frequency characteristic can be improved.

When the porous carbide 213 is previously impregnated with the mixed liquid of methanol and moisture, a phenol resin layer is provided mainly on the outer portion of the porous carbide 213 after the phenol resin is hardened. This is effective for filling the holes of the porous carbide 213, reduction of weight of the acoustic diaphragm, and acquiring higher internal losses.

While it is preferable to use nitrogen gas as the anoxic atmosphere because it is inexpensive and is readily available, argon, high vacuum atmosphere, and the like can be used instead of the nitrogen gas.

In the present embodiment, mixed liquid of 50 wt % of methanol and 50 wt % of moisture is used, however, the mixed liquid should not be limited to such values and the percentage can be arbitrarily set according to characteristics of a required diaphragm. For example, more phenol resin films are applied to the outer portion of the porous carbide 213 when the mixed liquid is prepared with 70 wt % of methanol and 30 wt % of moisture, compared to the case of using a mixed liquid with 50 wt % of methanol and 50 wt % of moisture. Also, the mixed liquid should not be limited to methanol and any alcohols having a low boiling temperature such as ethanol can be used. Further, the present embodiment should not be limited to a phenol resin coating material with 40 wt % of moisture and 10 wt % of alcohol and the optical density value should be arbitrarily set according to the weight or properties of a required acoustic diaphragm. For example, in order to provide a diaphragm requiring a large mechanical strength, the percentage of phenol resin is increased with 10 wt % of moisture and 10 wt % of alcohol so as to increase the amount of phenol resin attached thereto. As a result, mechanical strength of the diaphragm is improved.

### Third Embodiment

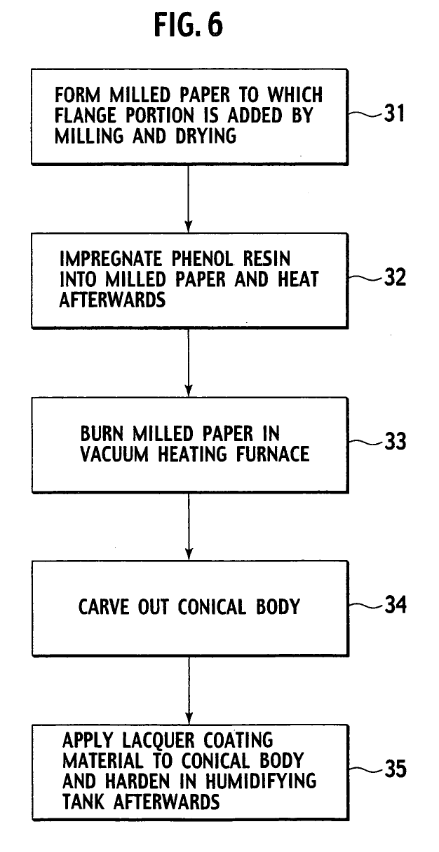

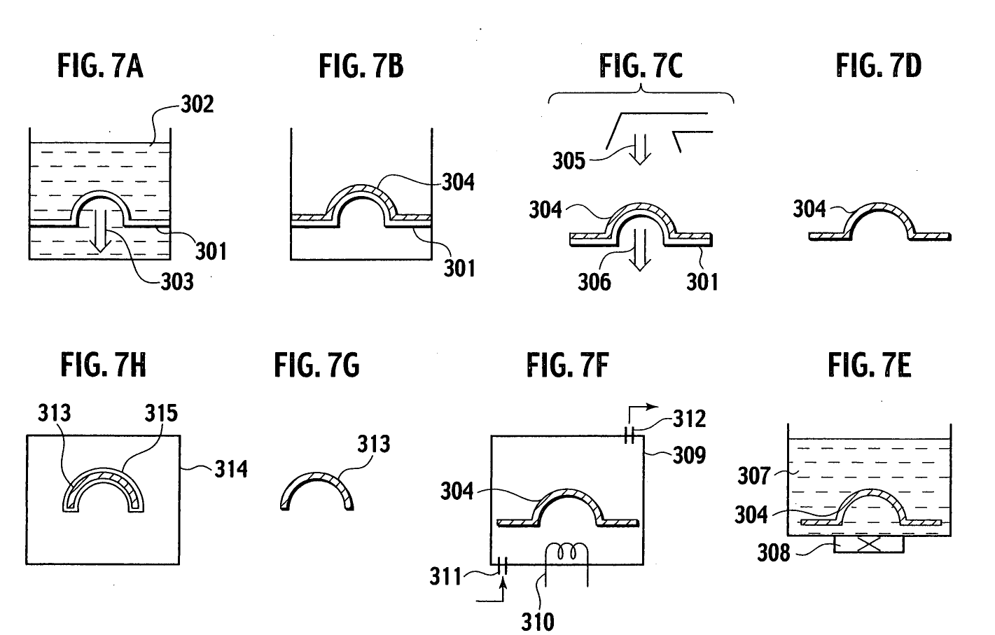

FIGS. 6 and 7A to 7H are explanatory diagrams of a production method according to a third embodiment.

At a first step 31 in FIG. 6, as shown in FIG. 7A, a previously formed mesh 301 having a center portion into a domical shape (hemispherical shape) is prepared. (Since the workpiece contracts due to a burning operation, the mesh may be formed larger than the size of the workpiece after the burning operation. For example, when the it is heated at 800° C., contraction of, for example, 25% in the longitudinal direction is taken into consideration, and the mesh may be formed larger by this value). The mesh 301 is put into dispersion liquid 302 into which mixture fiber of 90 wt % of linter (cotton fiber) 10 wt %+NBKP [Needle Bleach Kraft Pulp] (softwood fiber is made into pulp by kraft process and is further bleached) is dispersed, and the mixture fiber is milled into paper on the mesh 301. A reference number 303 represents a suction direction when paper is milled, and a reference number 304 in FIG. 7B represents milled paper. The mesh 301 can be made of metal such as brass, but the material is not limited to the value, and any strong, heat-resistance material can be used.

To remove moisture from the milled paper 304 on the mesh 301, hot air 305 (e.g., in a range of 100° C. to 200° C., as an example, at 150° C.) is blown on the milled paper 304 and the mesh 301 is vacuum-sucked from below at the same time as shown in FIG. 7C. A reference number 306 represents the vacuum-suction airflow.

At a second step 32 in FIG. 6, the milled paper 304 is detached from the mesh 301 as shown in FIG. 7D, and is immediately immersed in an alcohol solution 307 of phenol resin (phenol resin containing ratio is about 15 wt %) as shown in FIG. 7E, and the alcohol solution 307 impregnates the milled paper 304. At that time, the entire alcohol solution 307 of phenol resin is subjected to ultrasonic oscillation for about five minutes by an ultrasonic oscillator 308 so that the alcohol solution 307 fully impregnates into the milled paper 304.

The milled paper 304 is taken out from the solution 307 and sufficiently dried, and the milled paper 304 is then heated for about ten minutes at about 180° C. so that the phenol resin, which is a short molecule, is brought into a high polymer state.

Next, at a third step 33 in FIG. 6, as shown in FIG. 7F, the milled paper 304 impregnated with phenol resin is placed in a vacuum heating furnace 309, and is heated from a room temperature to 800° C. by a heater 310 in a substantially anoxic atmosphere (for example, nitrogen gas atmosphere). After the milled paper 304 is held for 30 minutes at 800° C., it is gradually cooled to the room temperature and is taken out from the furnace. With this step, the organic matter included in the milled paper 304 is carbonized. Thus, a large number of fine holes are formed in the milled paper 304 so as to be porous. A reference number 311 represents an introduction port for nitrogen gas or the like, and a reference number 312 represents a discharge port for nitrogen gas or the like.

Next, at a fourth step 34 in FIG. 6, as shown in FIG. 7G, a domical body of a porous carbide 313 is carved out by cutting. When paper is milled, if a small step portion is formed at a boundary between the conical shaped portion and the flat portion of the milled paper 304, it can be cut by a router or a laser cutter, or the like using the small step portion as a guideline, so it is possible to obtain a precise shape.

Next, at a fifth step 35 in FIG. 6, firstly, a (Japanese) lacquer coating material composed of a solution, which is obtained by diluting a purified lacquer solution with kerosene by weight ratio of 1:1, is applied to edges and entire surface of the porous carbide 313. Here, the lacquer coating material refers to an undiluted lacquer solution made by filtering, dispersing, and thermal dehydrating a raw lacquer so as to include about 5 wt % of moisture. The undiluted lacquer solution may be obtained by diluting an undiluted lacquer solution (name of product: MR Kurosugurome produced by Sato Kimimatsu Shoten, Co., Ltd.) composed of 80 wt % to 85 wt % of urushiol, 8 wt % to 12 wt % of polysaccharides, and 4 wt % to 5 wt % of moisture into 1 to 5 times. After applying the lacquer coating material on the porous carbide 313, in the fifth step 35, as shown in FIG. 7H, the porous carbide 313 is placed in a humidifying tank 314 and left at rest for 24 hours under an atmosphere at a temperature of 30° C. and a relative humidity of 60%.

After the porous carbide 313 is completely hardened, the same lacquer coating material is further applied to the edge portions and entire surface of the porous carbide 313. Then, again, it is placed in the humidifying tank 314 and is left at rest for 24 hours under the atmosphere 315 at a temperature of 30° C. and a relative humidity of 60%. The porous carbide 313 which is completely hardened again is sufficiently effective for filling the fine openings so that air leakage is prevented when the diaphragm is used as an acoustic diaphragm. A reference 315 in FIG. 7H represents a lacquer layer which works as a filling layer.

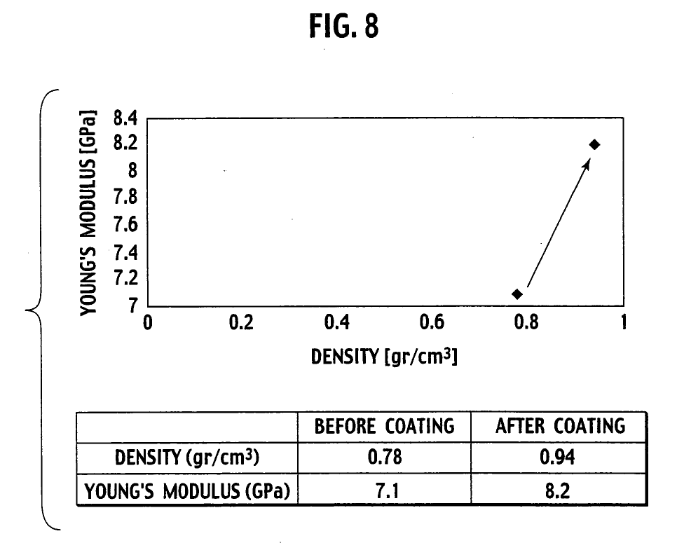

Further, increased weight of the porous carbide 313, which is completely hardened again after being left for about 24 hours under the atmosphere at about 30° C. and 60% (relative humidity) is about 20 wt % (compared to the porous carbide 313 before being coated by the lacquer coating material composed of a purified lacquer solution). However, the weight is within a range for use as required as an acoustic diaphragm and the Young's modulus increases about 15% from 7.1 GPa of the workpiece before coating to 8.2 GPa of the workpiece after coating (compared to the porous carbide 313 before being coated by the lacquer coating material). As a result, a sufficient strength to avoid damage in an assemble process of a speaker using the acoustic diaphragm can be obtained. FIG. 8 shows a relation between the Young's modulus and the density before and after coating. According to this sample, the thickness of the lacquer layer was within a range of about 1 μm to 20 μm and the average was 5 μm. This thickness is sufficient for the above described effect.

While it is preferable to use nitrogen gas as the anoxic atmosphere because it is inexpensive and is readily available, argon, high vacuum atmosphere, and the like can be used other than the nitrogen gas.

Here, urushiol is used as the lacquer. As other lacquers, laccol and thitsiol may be used. However, the obtained layers of those elements are lower in its strength compared to a layer made of urushiol. Thus, for an acoustic diaphragm requiring a certain degree of strength, urushiol is the most preferable. However, in the case of an acoustic diaphragm which does not require high degree of strength, laccol or thitsiol may be used in the present invention. According to this embodiment of the present invention, urushiol, laccol, and thitsiol are referred as a urushiol group for descriptive purposes. In addition, in all other embodiments of the present invention, “urushiol” may be understood as the “urushiol group”.

### Fourth Embodiment

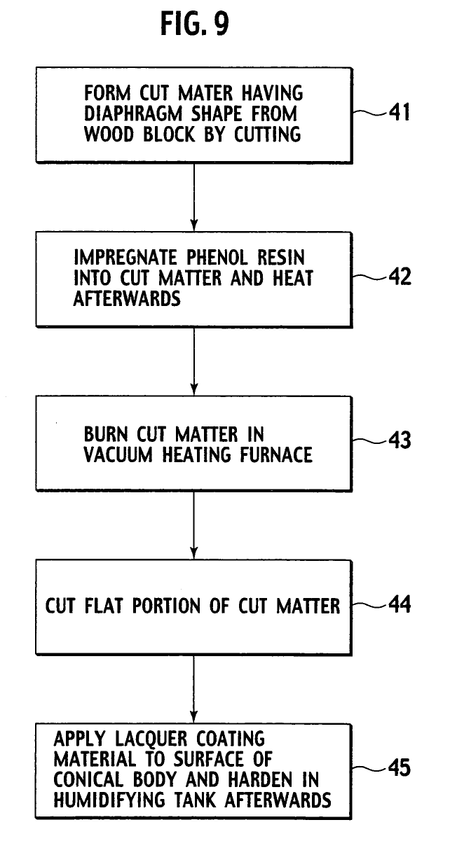

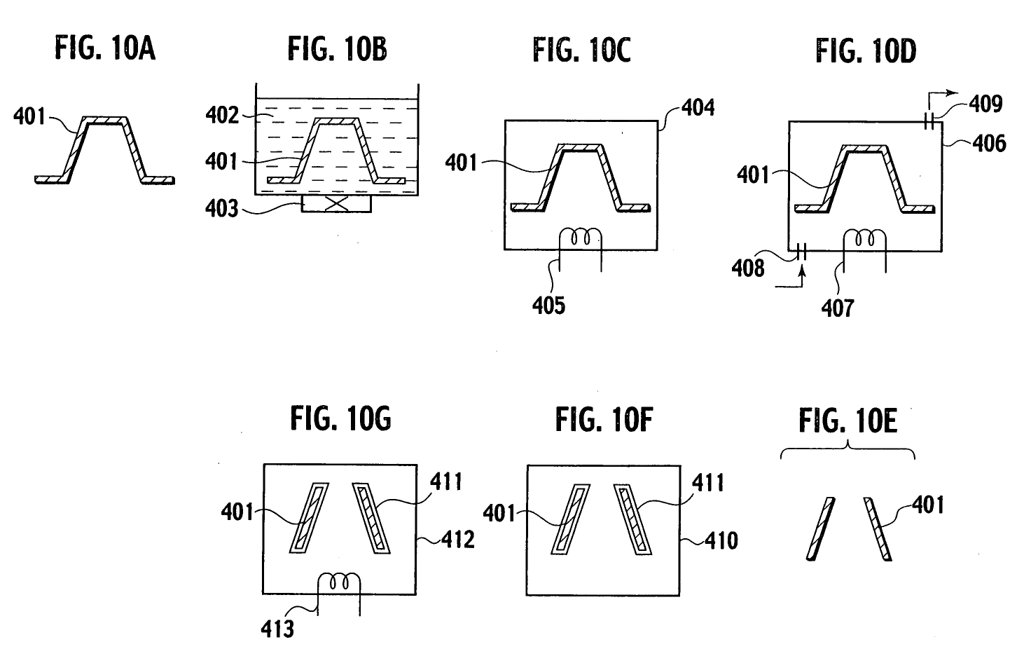

FIGS. 9 and 10A to 10G are explanatory diagrams of a production method according to the fourth embodiment.

At a first step 41 in FIG. 9, as shown in FIG. 10A, a sectionally hat-shaped cut matter 401, having a center portion, is previously formed into a conical shape (truncated shape). (Since the workpiece contracts due to a burning operation, the conical shaped portion may be formed larger than the size of the workpiece after the burning operation. For example, when it is heated at 800° C., contraction of, for example, 25% in the longitudinal direction is taken into consideration, and the mesh may be formed larger by this value).

At a second step 42 in FIG. 9, the cut matter 401 is immersed in an alcohol solution 402 of phenol resin (phenol resin containing ratio is about 15 wt %) as shown in FIG. 10B, and the alcohol solution 402 is impregnated into the cut matter 401. At that time, the entire phenol solution 402 is subjected to ultrasonic oscillation for about five minutes by an ultrasonic oscillator 403, so that the phenol solution 402 is fully impregnated into the cut matter 401.

The cut matter 401 is removed from the solution 402 and sufficiently dried. The cut matter 401 is placed in a heating furnace 404 and heated for about 15 minutes, for example, at about 180° C. by a heater 405 as shown in FIG. 10C, and the phenol resin, which is a short molecule, is brought into a high polymer state.

Next, at a third step 43 in FIG. 9, as shown in FIG. 10D, the cut matter 401 is placed in a vacuum heating furnace 406, and heated from a room temperature to 800° C. by a heater 407 in a nitrogen gas atmosphere. After the cut matter 401 is held for 30 minutes at 800° C., it is gradually cooled to the room temperature and is removed from the furnace. With this step, the organic matter included in the cut matter 401 is carbonized. Thus, a large number of fine holes are formed so that the cut matter 401 is porous. A reference number 408 represents an introduction port for nitrogen gas, and a reference number 409 represents a discharge port for nitrogen gas.

At a fourth step 44 in FIG. 9, as shown in FIG. 10E, the flat portion of a flange portion of the cut matter 401 is eliminated by cutting. When the cut matter 401 is cut in the first step, if a small step portion is formed at a boundary between the conical shaped portion and the flat portion of the cut matter 401. The cut matter 401 can be cut using the small step portion as a guideline, so it is possible to cut the flat portion accurately.

At a fifth step 45 in FIG. 9, firstly, a (Japanese) lacquer coating material composed of a solution, which is obtained by diluting a purified lacquer solution with kerosene by weight ratio of 1:1, is applied to predetermined portions of the cut matter 401. Here, the lacquer coating material refers to an undiluted lacquer solution which is made by filtering, dispersing, and thermal dehydrating a raw lacquer so as to include about 5 wt % of moisture. The undiluted lacquer solution may be obtained by diluting an undiluted lacquer solution (name of product: MR Kurosugurome produced by Sato Kimimatsu Shoten, Co., Ltd.) composed of 80 wt % to 85 wt % of urushiol, 8 wt % to 12 wt % of polysaccharides, and 4 wt % to 5 wt % of moisture into 1 to 5 times. After applying the lacquer coating material on the cut matter 401, in the fifth step 45, as shown in FIG. 10F, the cut matter 401 is placed in humidifying tank 410 and left at rest for 24 hours under an atmosphere at about 30° C. and relative humidity of 60%. Here, the predetermined portions represent two or more of the end face, front face, and rear face of the cut matter 401.

Further, as shown in FIG. 10G, the cut matter 401 is placed in a heating furnace 412 and heated by a heater 413, for example, for 30 minutes at 150° C. The process shown in FIGS. 10F and 10G are repeated as needed in order to achieve a sufficient filling effect of the fine holes. When an efficient filling effect is achieved, air leakage can be completely prevented when it is used as an acoustic diaphragm. Here, a reference 411 shown in FIGS. 10F and 10G represents a lacquer layer as a filling layer.

Since the lacquer coating material permeates into holes of the porous carbide with the solution and forms a film by being applied to the porous carbide or immersing the porous carbide in the solution, the occurrence of fractures of the carbonized diaphragm will be remarkably reduced. Further, since the thickness of the lacquer coating film is thin, a lightweight and strong carbonized material, without increasing the weight of the diaphragm too much, is realized. In addition, since the lacquer coating film is provided, a diaphragm having high internal losses is realized. Accordingly, when the diaphragm is used as a speaker, distortion is prevented and generated strain component are absorbed so that frequency characteristics are improved.

According to the present embodiment, lacquer coating material of the foregoing purified lacquer solution is used. However, it is not limited to the diluted condition and a sufficient filling effect can be achieved with a condition that a weight rate of lacquer and kerosene is set, for example, 1:10.

### Fifth Embodiment

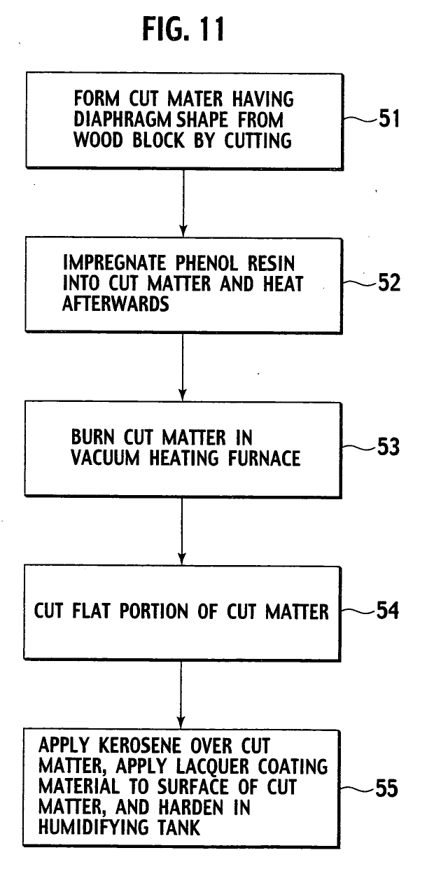

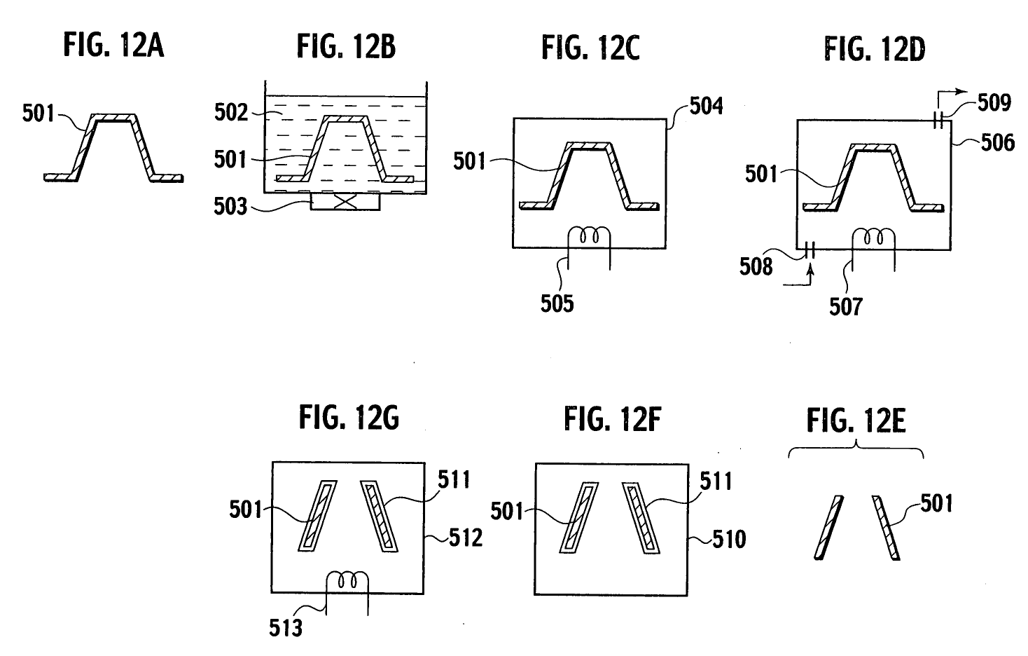

Next, a fifth embodiment of the present invention will be described. FIGS. 11 and 12A to 12G are explanatory diagrams of a product method according to the fifth embodiment.

At a first step 51 in FIG. 11, a block of a Japanese cypress, which is a softwood, is cut to obtain a substantially hat shaped cut matter 501 having a conical (truncated) portion. (Since the conical portion is contracted due to a burning operation, this portion is formed larger than the size thereof after the burning operation. In this case, since it is heated at 800° C., contraction of 25% is taken into consideration, and the portion is formed larger by this value).

At a second step 52 in FIG. 11, as shown in FIG. 12B, the cut matter 501 is immersed in an alcohol solution 502 of phenol resin (ratio of phenol resin is about 15%) and impregnated with the solution 502. The entire phenol solution 502 in which the cut matter 501 is impregnated is subjected to ultrasonic oscillation for about five minutes by an ultrasonic oscillator 503 so that the solution 502 fully impregnates the cut matter 501.

The cut matter 501 is taken out from the solution 502 and is sufficiently dried. It is placed in a heating furnace 504 as shown in FIG. 12C and is heated for about 15 minutes at about 180° C. by a heater 505, and the phenol resin, which is a short molecule, is brought into a high polymer state.

Next, at a third step 53 in FIG. 11, as shown in FIG. 12D, the cut matter 501 in which phenol resin is brought into a high polymer state is placed in a vacuum heating furnace 506, and it is heated from a room temperature to 800° C. by a heater 507 in a nitrogen gas atmosphere. After the cut matter 501 is held for 30 minutes at 800° C., it is gradually cooled to the room temperature and is taken out from the furnace. With this step, the organic matter included in the cut matter 501 is carbonized. Thus, a large number of fine holes are formed in the cut matter 501 so that the cut matter 501 is porous. A reference number 508 represents an introduction port for nitrogen gas, and a reference number 509 represents a discharge port for nitrogen gas.

At a fourth step 54 in FIG. 11, as shown in FIG. 12E, the flat portion of the cut matter 501 is eliminated by cutting. At the time of the cutting operation at the first step, if a small step portion is previously formed between the conical portion and the flange portion of the cut matter 501, it can be cut using the small step portion as a guideline, so it is possible to precisely eliminate the flange portion accurately.

At a fifth step 55 in FIG. 11, firstly, after kerosene is applied to predetermined portions of the cut matter 501, a (Japanese) lacquer coating material composed of a solution, which is obtained by diluting a purified lacquer solution with kerosene by weight ratio of 1:1, is applied to predetermined portions of the cut matter 501. Here, the lacquer coating material refers to an undiluted lacquer solution which is made by filtering, dispersing, and thermal dehydrating a raw lacquer so as to include about 5 wt % of moisture. The undiluted lacquer solution may be obtained by diluting an undiluted lacquer solution (name of product: MR Kurosugurome produced by Sato Kimimatsu Shoten, Co., Ltd.) composed of 80 wt % to 85 wt % of urushiol, 8 wt % to 12 wt % of polysaccharides, and 4 wt % to 5 wt % of moisture into 1 to 5 times. After applying the lacquer coating material on the cut matter 501, in the fifth step 55, as shown in FIG. 12G, the cut matter 501 is placed in humidifying tank 510 and left at rest for 24 hours under an atmosphere at about 30° C. and relative humidity of about 60%.

The processes shown in FIGS. 12F and 12G are repeated as needed in order to achieve a sufficient filling effect. When an efficient hole filling effect is achieved, air leakage can be completely prevented when the cut matter is made as an acoustic diaphragm. Here, a reference 511 in FIGS. 12F and 12G represents a lacquer layer as a filling layer.

According to the acoustic diaphragm of the present embodiment, a complete hole filling effect can be obtained. Further, kerosene prevents the lacquer coating material from permeating into the diaphragm so that lacquer is thin at the inner portion of the diaphragm and thick at the outer portion. It is effective for reducing the weight of the diaphragm and increasing the internal losses. As a result, an excellent acoustic diaphragm is achieved. In other words, when the lacquer coating material is applied, it permeates into the holes of the porous carbide so that the probability of fracture of the carbonized diaphragm is remarkably reduced. Further, since the phenol resin coating material permeates into the holes located near the surface of the porous carbide and forms a phenol resin membrane inside of the holes near the surface of the porous carbide, interior spaces which are not impregnated with the phenol resin coating material. Accordingly, the strength of the carbonized material, as an acoustic diaphragm, is improved while weight saving is maintained and weight of the acoustic diaphragm is not increased so much. When the diaphragm is used as a speaker, due to an increase of internal losses because of the phenol resin layer, distortion is prevented and generated strain components are absorbed so that frequency characteristics are improved. In this case, it was found that the thickness of the diaphragm was about 1 mm, and a lacquer layer was concentrated at the portion near the surfaces, about 20% of the length (depth) of the thickness of the diaphragm.

Since phenol resin is a material that can withstand long term use under a high-temperature environment of over 100° C., an acoustic diaphragm according to the present invention can be applied to a high-power speaker. Since phenol resin is highly resistant to humidity, the present invention can provide a speaker which can stand long term use in a high-humidity environment.

Further, the present invention provides an acoustic diaphragm that visually has an expensive appearance. The color of the diaphragm can be changed by adding a substance such as copper and artistic (beautiful) appearance similar to “MAKI-e” (Maki-e is Japanese gold or silver lacquer sprinkled with metal powder as a decoration using a makizutsu or a kebo brush) can be obtained so that the present invention can provide a picturesque speaker.

Further, the lacquer coating material does not contain a synthetic resin such as petroleum solvents, so that it is effective for use in a global environment, similar to a case of using natural materials for a diaphragm having a high carbonization ratio.

Further, when the end face of the workpiece is included as the portion where the lacquer coating material is applied, air leakage can be prevented more effectively.

According to the present embodiment, kerosene is applied before lacquer is applied, however, the present embodiment is not limited to a hydrocarbon solvent such as kerosene and any other liquid, such as liquid composed of water and ethanol, may be employed if it evaporates under a condition so that the lacquer is hardened.

### (An Example of a Speaker)

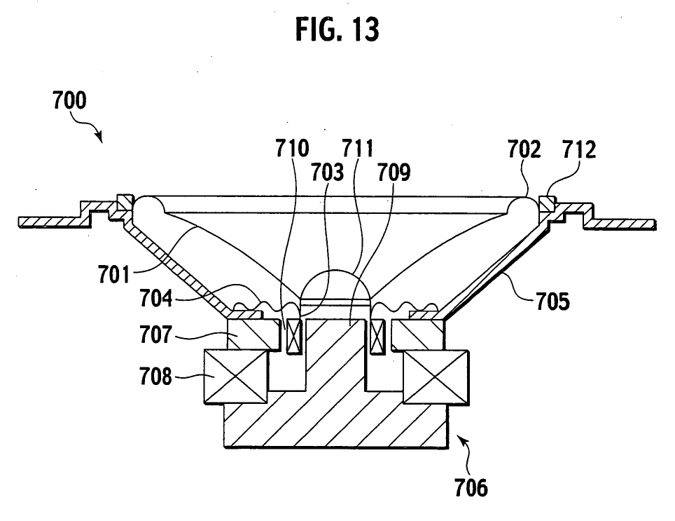

In FIG. 13, a rubber edge 702 having a predetermined shape is adhered to an entire outer periphery of a conical acoustic diaphragm 701 formed by any one of the production methods according to the first to the five embodiments, and a bobbin of a voice coil 703 having a predetermined shape (a predetermined damper 704 is previously adhered to the bobbin) is adhered to a center of the acoustic diaphragm 701.

These integral three parts are attached by adhesion to a predetermined speaker housing 705 (a predetermined magnetic circuit 706 is previously provided). A conductive metal wire (not shown) is pulled out from the voice coil 703. The metal wire is connected to a terminal (not shown, and it is previously insulated from the metal housing 705) mounted on the housing 705.

The magnetic circuit 706 includes a ring-shaped plate 707, a ring-shaped magnet 708, a pole 709, and the like. The voice coil 703 is loosely inserted into a magnetic gap 710 formed between the plate 707 and the pole 709. The speaker is completed by polarizing the magnet 708. A reference number 711 represents a dust cap for preventing foreign matter from entering the voice coil 703. A reference number 712 represents an annular gasket for pressing an end of the edge 702.

As compared with a speaker having a wood acoustic diaphragm with the same shape, the speaker 700 has a high carbonization ratio, and has excellent acoustic properties with a clear reproduced sound and small distortion.

Embodiments of the present invention are described above with detailed examples, however, it should be understood that many modifications and adaptations of the invention will become apparent to those skilled in the art and it is intended to encompass such obvious modifications and changes in the scope of the claims appended hereto.

What is claimed is:

1. A method of producing an acoustic diaphragm comprising the steps of:
forming a workpiece having a shape of the acoustic diaphragm by using a natural material which can be carbonized by burning;
impregnating a solution including phenol resin into the workpiece;
heating the workpiece to bring the phenol resin into a high polymer state;
burning the workpiece in a substantially anoxic atmosphere to carbonize the natural material after the heating step; and
applying or impregnating the workpiece with a coating material of a solution including phenol resin after the burning step.

2. A method of producing an acoustic diaphragm comprising the steps of:
forming a workpiece having a shape of the acoustic diaphragm by using a natural material which can be carbonized by burning;
impregnating a solution including phenol resin into the workpiece;
heating the workpiece to bring the phenol resin into a high polymer state;
impregnating a liquid mixture of alcohol and water into the workpiece after the heating step;
burning the workpiece in a substantially anoxic atmosphere to carbonize the natural material after the impregnating step of impregnating the liquid mixture; and
applying or impregnating the workpiece with a coating material of a solution including phenol resin after the burning step.

3. A method of producing an acoustic diaphragm comprising the steps of:
forming a workpiece having a shape of the acoustic diaphragm by using a natural material which can be carbonized by burning;
impregnating a solution including phenol resin into the workpiece;
heating the workpiece to bring the phenol resin into a high polymer state;
burning the workpiece in a substantially anoxic atmosphere to carbonize the natural material after the heating step;
applying or impregnating the workpiece with a lacquer coating material including urushiol after the burning step; and
hardening the lacquer coating material by keeping the workpiece in a humid condition or heating the workpiece at a predetermined temperature.

4. A method of producing an acoustic diaphragm comprising the steps of:
forming a workpiece having a shape of the acoustic diaphragm by using a natural material which can be carbonized by burning;
impregnating a solution including phenol resin into the workpiece;
heating the workpiece to bring the phenol resin into a high polymer state;
burning the workpiece in a substantially anoxic atmosphere to carbonize the natural material after the heating step;
impregnating a solution including a hydrocarbon solvent into the workpiece after the burning step; and
applying or impregnating the workpiece with a lacquer coating material including urushiol after the impregnating step of impregnating the solution including the hydrocarbon solvent; and
hardening the lacquer coating material by keeping the workpiece in a humid condition or heating the workpiece at a predetermined temperature.

5. An acoustic diaphragm comprising:
a porous carbide conical body including a carbide of a natural material and a carbide of phenol resin; and
a hardened film of phenol resin provided at least one of a surface of the porous carbide conical body and in the porous carbide conical body.

6. The acoustic diaphragm of claim 5, wherein the porous carbide conical body and the hardened film are manufactured by a process comprising:
forming a workpiece having a shape of the acoustic diaphragm by using a natural material which can be carbonized by burning;
impregnating a solution including phenol resin into the workpiece;
heating the workpiece to bring the phenol resin into a high polymer state;
burning the workpiece in a substantially anoxic atmosphere to carbonize the natural material after the heating step; and
applying or impregnating the workpiece with a coating material of a solution including phenol resin after the burning step.

7. The acoustic diaphragm according to claim 5, wherein the porous carbide conical body and the hardened film are manufactured by a process comprising:
forming a workpiece having a shape of the acoustic diaphragm by using a natural material which can be carbonized by burning;
impregnating a solution including phenol resin into the workpiece;
heating the workpiece to bring the phenol resin into a high polymer state;
impregnating a liquid mixture of alcohol and water into the workpiece after the heating step;
burning the workpiece in a substantially anoxic atmosphere to carbonize the natural material after the impregnating step of impregnating the liquid mixture; and
applying or impregnating the workpiece with a coating material of a solution including phenol resin after the burning step.

8. An acoustic diaphragm comprising:
a porous carbide conical body including a carbide of a natural material and a carbide of phenol resin; and
a lacquer coating material layer including urushiol provided at least one of a surface of the porous carbide conical body and in the porous carbide conical body.

9. The acoustic diaphragm according to claim 8, wherein the porous carbide conical body and the lacquer coating material layer are manufactured by the process comprising:
forming a workpiece having a shape of the acoustic diaphragm by using a natural material which can be carbonized by burning;
impregnating a solution including phenol resin into the workpiece;
heating the workpiece to bring the phenol resin into a high polymer state;
burning the workpiece in a substantially anoxic atmosphere to carbonize the natural material after the heating step;
applying or impregnating the workpiece with a lacquer coating material including urushiol after the burning step; and
hardening the lacquer coating material by keeping the workpiece in a humid condition or heating the workpiece at a predetermined temperature.

10. The acoustic diaphragm according to claim 8, wherein the porous carbide conical body and the lacquer coating material layer are manufactured by the process comprising:
forming a workpiece having a shape of the acoustic diaphragm by using a natural material which can be carbonized by burning;
impregnating a solution including phenol resin into the workpiece;
heating the workpiece to bring the phenol resin into a high polymer state;
burning the workpiece in a substantially anoxic atmosphere to carbonize the natural material after the heating step;
impregnating a solution including a hydrocarbon solvent into the workpiece after the burning step; and
applying or impregnating the workpiece with a lacquer coating material including urushiol after the impregnating step of impregnating the solution including the hydrocarbon solvent; and
hardening the lacquer coating material by keeping the workpiece in a humid condition or heating the workpiece at a predetermined temperature.

11. A speaker that uses the acoustic diaphragm according to claim 5.

12. A speaker that uses the acoustic diaphragm according to claim 6.

13. A speaker that uses the acoustic diaphragm according to claim 8.

14. A speaker that uses the acoustic diaphragm according to claim 9.
